(19) United States
(12) Patent Application Publication
(10) Pub. No.: US 2002/0144132 A1
(43) Pub. Date: Oct. 3, 2002

(54) Apparatus and methods of preventing an adulteration attack on a content screening algorithm

(75) Inventors: Martin Rosner, Cortlandt Manor, NY (US); Michael A. Epstein, Spring Valley, NY (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/966,401

(22) Filed: Sep. 28, 2001

Related U.S. Application Data
(60) Provisional application No. 60/279,639, filed on Mar. 29, 2001.

(51) Int. Cl. H04L 9/00

(52) U.S. Cl. 713/189

(57) ABSTRACT

Methods and apparatus for preventing an attack on a screening algorithm. A method includes the steps of identifying content to be downloaded, determining a total number of sections of a predetermined duration of time in the content to be downloaded, and screening a predetermined number of sections of the total number of sections to determine whether the predetermined number of sections verify correctly through the screening algorithm. The number of predetermined sections screened during the screening step of the method of preventing an attack on a screening algorithm is two for content having a duration of three minutes or less and is incremented by one for each one minute of duration over the initial three minutes.

### CROSS REFERENCE TO RELATED APPLICATION

This application claims priority to the U.S. provisional patent application identified by Ser. No. 60/279,639, filed on Mar. 29, 2001, the disclosure of which is incorporated by reference herein.

### FIELD OF THE INVENTION

The present invention relates generally to the field of secure communication, and more particularly to techniques for preventing an attack on a secure content screening algorithm based on adulteration of marked content.

### BACKGROUND OF THE INVENTION

Security is an increasingly important concern in the delivery of music or other types of content over global communication networks such as the Internet. More particularly, the successful implementation of such network-based content delivery systems depends in large part on ensuring that content providers receive appropriate copyright royalties and that the delivered content cannot be pirated or otherwise subjected to unlawful exploitation.

With regard to delivery of music content, a cooperative development effort known as Secure Digital Music Initiative (SDMI) has recently been formed by leading recording industry and technology companies. The goal of SDMI is the development of an open, interoperable architecture for digital music security. This will answer consumer demand for convenient accessibility to quality digital music, while also providing copyright protection so as to protect investment in content development and delivery. SDMI has produced a standard specification for portable music devices, the SDMI Portable Device Specification, Part 1, Version 1.0, 1999, and an amendment thereto issued later that year, each of which is incorporated by reference herein. The longer-term effort of SDMI is currently working toward completion of an overall architecture for delivery of digital music in all forms.

The illicit distribution of copyright material deprives the holder of the copyright legitimate royalties for this material, and could provide the supplier of this illicitly distributed material with gains that encourage continued illicit distributions. In light of the ease of information transfer provided by the Internet, content that is intended to be copy-protected, such as artistic renderings or other material having limited distribution rights, is susceptible to wide-scale illicit distribution. For example, the MP3 format for storing and transmitting compressed audio files has made the wide-scale distribution of audio recordings feasible, because a 30 or 40 megabyte digital audio recording of a song can be compressed into a 3 or 4 megabyte MP3 file. Using a typical 56 kbps dial-up connection to the Internet, this MP3 file can be downloaded to a user's computer in a few minutes. Thus, a malicious party could read songs from an original and legitimate CD, encode the songs into MP3 format, and place the MP3 encoded song on the Internet for wide-scale illicit distribution. Alternatively, the malicious party could provide a direct dial-in service for downloading the MP3 encoded song. The illicit copy of the MP3 encoded song can be subsequently rendered by software or hardware devices, or can be decompressed and stored onto a recordable CD for playback on a conventional CD player.

A number of schemes have been proposed for limiting the reproduction of copy-protected content. SDMI and others advocate the use of “digital watermarks” to identify authorized content. U.S. Pat. No. 5,933,798, “Detecting a watermark embedded in an information system,” issued Jul. 16, 1997 to Johan P. Linnartz, discloses a technique for watermarking electronic material, and is incorporated by reference herein. As in its paper watermark counterpart, a digital watermark is embedded in the content so as to be detectable, but unobtrusive. An audio playback of a digital music recording containing a watermark, for example, will be substantially indistinguishable from a playback of the same recording without the watermark. A watermark detection device, however, is able to distinguish these two recordings based on the presence or absence of the watermark. Because some content may not be copy-protected and hence may not contain a watermark, the absence of a watermark cannot be used to distinguish legitimate from illegitimate material. On the contrary, the absence of a watermark is indicative of content that can be legitimately copied freely.

Other copy protection schemes are also available. For example, European patent EP983687A2, “Copy Protection Schemes for Copy Protected Digital Material,” issued Mar. 8, 2000 to Johan P. Linnartz and Johan C. Talstra, presents a technique for the protection of copyright material via the use of a watermark “ticket” that controls the number of times the protected material may be rendered, and is incorporated by reference herein.

An accurate reproduction of watermarked material will cause the watermark to be reproduced in the copy of the watermarked content. An inaccurate or lossy reproduction of watermarked content, however, may not provide a reproduction of the watermark in the copy of the material. A number of protection schemes, including those of SDMI, have taken advantage of this characteristic of lossy reproduction to distinguish legitimate material from illegitimate material, based on the presence or absence of an appropriate watermark. In the SDMI scenario, two types of watermarks are defined: “robust” watermarks, and “fragile” watermarks. A robust watermark is one that is expected to survive a lossy reproduction that is designed to retain a substantial portion of the original content, such as an MP3 encoding of an audio recording. That is, if the reproduction retains sufficient information to allow a reasonable rendering of the original recording, the robust watermark will also be retained. A fragile watermark, on the other hand, is one that is expected to be corrupted by a lossy reproduction or other illicit tampering.

In the SDMI scheme, the presence of a robust watermark indicates that the content is copy-protected, and the absence or corruption of a corresponding fragile watermark when a robust watermark is present indicates that the copy-protected content has been tampered with in some manner. An SDMI compliant device is configured to refuse to render watermarked material with a corrupted watermark, or with a detected robust watermark but an absent fragile watermark, except if the corruption or absence of the watermark is justified by an “SDMI-certified” process, such as an SDMI compression of copy-protected content for use on a portable player. For ease of reference and understanding, the term “render” is used herein to include any processing or transferring of the content, such as playing, recording, converting, validating, storing, loading, and the like. This scheme serves to limit the distribution of content via MP3 or other compression techniques, but does not affect the distribution of counterfeit unaltered (uncompressed) reproductions of content. This limited protection is deemed commercially viable, because the cost and inconvenience of downloading an extremely large file to obtain a song will tend to discourage the theft of uncompressed content.

Despite SDMI and other ongoing efforts, existing techniques for secure distribution of music and other content suffer from a number of significant drawbacks. For example, SDMI has recently proposed the use of a new screening algorithm referred to as SDMI Lite. SDMI Lite essentially screens only two sections of the content which is being downloaded. This limited amount of screening leaves the SDMI Lite and other content based screening algorithms susceptible to successful attacks.

Thus, a need exists for a method of preventing an adulteration attack on a content screening algorithm.

### SUMMARY OF THE INVENTION

The present invention provides apparatus and methods of preventing an attack on the proposed SDMI Lite screening algorithm as described herein as well as other content based screening algorithms. The present invention is premised on the concept of improving the effectiveness of the screening algorithm to the point where an attacker's chance of successfully admitting illicit content past the screen is greatly decreased, without sacrificing performance.

An advantage of the present invention is that it cures at least one fault in the prior art screening algorithms. It is only through the successful identification and prevention of faults that the underlying prior art screening algorithms can be improved to provide convenient, efficient and cost-effective protection for all content providers.

In accordance with one aspect of the present invention, a method of preventing an attack on a screening algorithm includes the steps of identifying content to be downloaded, determining a total number of sections of a predetermined duration of time in the content to be downloaded, and screening a predetermined number of sections of the total number of sections to determine whether the predetermined number of sections verify correctly through the screening algorithm.

In another aspect of the present invention, the number of predetermined sections screened during the screening step of the method of preventing an attack on a screening algorithm is two for content having a duration of three minutes or less and is incremented by one for each one minute of duration over the initial three minutes.

These and other features and advantages of the present invention will become more apparent from the accompanying drawings and the following detailed description.

### BRIEF DESCRIPTION OF THE DRAWINGS

FIG. 1 is a schematic diagram illustrating a general overview of the present invention;

FIG. 2 is a flow diagram illustrating the steps of a method of preventing an attack on a screening algorithm based on adulteration of marked content in accordance with an illustrative embodiment of the present invention; and

FIG. 3 is a table illustrating the probabilities of success for an attacker when undertaking to download illicit material, such as a song, expressed in terms of the length of the song versus the number of legitimate sections inserted into the song.

### DETAILED DESCRIPTION OF THE INVENTION

The present invention provides apparatus and methods which prevent an attack on screening algorithms that rely on a sampling of data, and, specifically, the proposed SDMI Lite screening algorithm as described herein. The apparatus and methods are generally directed to reducing an attacker's chances of successfully downloading illicit content, while balancing the number of sections screened versus the reduction in performance time and efficiency caused by screening many sections.

Advantageously, the methods and apparatus of the invention prevent attacks on content-based security screening algorithms. The prevention of successful attacks on screening algorithms in accordance with the present invention will provide convenient, efficient and cost-effective protection for all content providers.

One goal of SDMI is to prevent the unlawful and illicit distribution of content on the Internet. In an attempt to accomplish this goal, SDMI has proposed methods of screening content that has been marked to be downloaded. One such proposal is the previously-mentioned SDMI Lite screening algorithm. Generally, the SDMI Lite screening algorithm randomly screens only two sections of the marked content to determine whether the content is legitimate. Therefore, for a song which is three minutes in length, only thirty seconds of the song is being checked (assuming fifteen second test sections). The thirty seconds represents only one-sixth of the total content of the song. The new screening algorithm in accordance with the present invention increases the performance of existing screening algorithms.

Generally, one way in which an attack on content based screening methods is successfully accomplished is by initiating an adulteration attack by inserting sections of legitimate content into the illicit content. The inserted sections are self-consistent in the sense that, if the inserted section is selected by the screening algorithm, the inserted section will verify correctly through the screening algorithm. The screening algorithms described herein include the SDMI Lite algorithm and other content-based screening algorithms, such as the CDSafe algorithm. The CDSafe algorithm is described more fully in pending U.S. patent application Ser. No. 09/536,944, filed Mar. 28, 2000, in the name of inventors Toine Staring, Michael Epstein and Martin Rosner, entitled “Protecting Content from Illicit Reproduction by Proof of Existence of a Complete Data Set via Self-Referencing Sections,” and incorporated by reference herein.

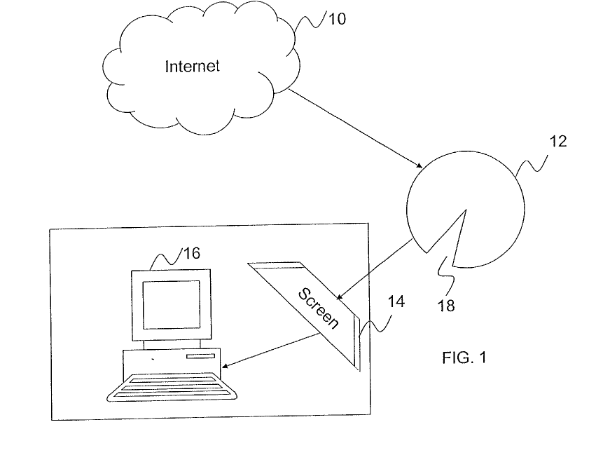

Referring now to FIG. 1, one method of attacking the SDMI Lite screening algorithm and the CDSafe algorithm is to “adulterate” the content that is proposed to be downloaded from an external source such as, for example, the Internet 10. As used herein, the term “adulterate” refers to the act of inserting a section 18 from content that is known to be legitimate into content that the attacker knows to be illegitimate, such that the illegitimate content 12 will pass the screening algorithm 14. That is, if the screening algorithm 14 can be tricked into believing that the proposed content to be downloaded is in fact different content than the content that is actually being downloaded, then the screening algorithm 14 will allow the content 12 to be downloaded despite the fact that some portion of the downloaded content is actually being illegally distributed.

Although illustrated as a separate element, screening algorithm 14 may be resident within memory within the personal computer 16, and executed by a processor of the personal computer 16. Once the content is downloaded, it may be written to a compact disk, personal digital assistant (PDA) or other device such as a memory coupled to or otherwise associated with a personal computer 16. At this point, the inserted (adulteration) material may be removed to restore the integrity of the illicit content. Although shown in FIG. 1 as a personal computer, element 16 may be implemented as a PDA, digital music player, wireless telephone or any other device having a processor and associated memory.

The method of attack described herein is made possible since only a small portion of the marked content was being screened by the prior screening methods. This type of attack would not be possible if every section of the marked content were screened to ensure that the marked content is legitimate content. However, screening every section would detrimentally affect the performance of the screening method since it is time consuming. Yet, since only two sections of the marked content are being screened in the above-noted SDMI Lite screening algorithm, the screening algorithm is susceptible to being circumvented in accordance with the type of attack described herein.

In the following discussion the term “segment” will be used to indicate a contiguous block of content containing one or more sections of content.

In an embodiment of the present invention, two sections from the marked content will always be chosen and screened by the screening process during the first three minutes of the content, no matter what the length of the content is. These sections will generally be chosen at random. In a preferred embodiment, an additional section will be screened for every minute of content above and beyond the initial three minutes. It is also contemplated that this three minute threshold may be greater or less than three minutes. Thus, the likelihood of detecting illicit content will increase.

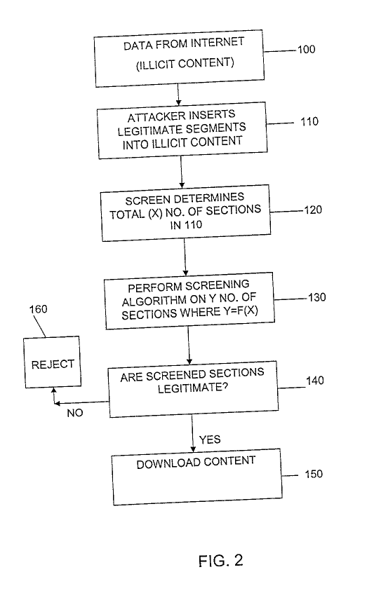

Referring now to FIG. 2, a flow diagram is shown illustrating the steps of the method of preventing an attack on a screening algorithm based on adulteration of the screened content, in accordance with another illustrative embodiment of the present invention.

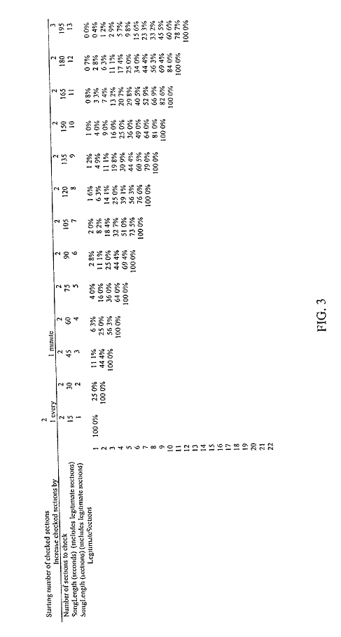

Step 100 represents illicit content such as, for example, data from the Internet. This illicit content is represented as content in FIG. 1. In step 110, an attacker will insert at least one section of legitimate content into the data from the Internet which was identified in step 100. The legitimate content is illustrated in FIG. 1 as reference numeral 18. It is contemplated that larger or smaller sections of legitimate content may be inserted into the illegitimate content as will be described below with reference to FIG. 3. Upon completion of step 110, the content is ready to be submitted to the screening process.

Commencing the screening process, as indicated in step 120, a determination is made regarding the number of sections, including legitimate and illegitimate sections, that exist in the content that is to be downloaded. Preferably, the length of the sections is fifteen (15) seconds, although other section durations may also be used. In step 130, a number of sections to be screened is calculated based on a predetermined function F:

Y=F(X)

where Y is equal to the number of sections to be screened; and X is equal to the total number of sections within the content being screened. The relationship between Y and X is defined by F. F is a subjective factor which is defined by a tradeoff made between the desired level of security versus the desired level of performance. The level of security is inversely proportional to the level of performance. Thus, the greater the degree of security required by the user, the more that the screening algorithm will sacrifice in performance. A numerical representation of this relationship is illustrated in FIG. 3.

In accordance with a preferred embodiment of the present invention, Y is equal to two for the first three minutes of content. The value of Y is incremented by one for each minute of content over the three minutes. Other values can be used in alternative embodiments.

Y number of sections are then screened in step 140, to determine whether the content passes the screening requirements. If an illegitimate section is detected, the content will be rejected, as indicated by step 160. If, however, the legitimate sections that were added by the attacker are detected, the content will pass the screening process and will be permitted to be downloaded as indicated by step 150.

Although the above-described method of preventing an attack is not a guarantee that a content-based screening algorithm will not be circumvented, the likelihood that the attacker will be able to successfully download illegitimate content decreases with the number of sections that are screened. For example, where the performance is not an issue, the screening algorithm may screen one-hundred percent of the content to ensure that illicit content is not being downloaded.

FIG. 3 is a table illustrating the probability of success for an attacker when attempting to download illicit material. More specifically, FIG. 3 lists the probabilities of downloading a plurality of different length illicit songs as a function of the number of legitimate sections present in the illicit song and further as a function of the number of sections that are scanned in accordance with the preferred embodiment of the present invention. The vertical axis lists the number of legitimate sections present in a song. The horizontal axis provides three categories of information: (1) the number of sections to be screened in accordance with the present invention; (2) the various song lengths in seconds; and (3) the number of fifteen second sections within the total song length. The probabilities listed in FIG. 3 are based on the assumption that the screening algorithm screens only two sections for the first three minutes of each song and one additional section for each additional minute of the song over the initial three minutes. The function F computed in FIG. 3 is just one implementation of the described invention.

As an example, with reference to FIG. 3, if the song length is 195 seconds (three minutes and fifteen seconds) and five (5) of the sections are legitimate sections that have been combined with eight (8) sections of illegitimate content, three (3) sections will be screened (two for the initial three minutes and one for the additional fifteen seconds) and the probability of getting the song through the screening process is five and seven-tenths percent (5.7%).

The above-described embodiments of the invention are intended to be illustrative only. For example, although the present invention has been described with reference to the content constituting a single song, the invention is equally applicable to the download of an entire compact disk, as well as numerous other types of content. These and numerous other embodiments within the scope of the following claims will be apparent to those skilled in the art.

What is claimed is:

1. A method of preventing an attack on a screening algorithm, the method comprising the steps of:
identifying content to be downloaded;
determining a total number of sections of a predetermined duration of time in the content to be downloaded; and
screening a predetermined number of sections of the total number of sections to determine whether the predetermined number of sections verify correctly through the screening algorithm wherein the predetermined number of sections is a function of a characteristic of the content.

2. The method of preventing an attack on a screening algorithm as recited in claim 1 wherein the screening algorithm is a Secure Digital Music Initiative screening algorithm.

3. The method of preventing an attack on a screening algorithm as recited in claim 1 wherein the screening algorithm relies on a sampling of data contained within the identified content.

4. The method of preventing an attack on a screening algorithm as recited in claim 1 wherein the identified content is downloaded from the Internet.

5. The method of preventing an attack on a screening algorithm as recited in claim 1 wherein the predetermined duration of time of one or more of the total number of sections is about fifteen seconds.

6. The method of preventing an attack on a screening algorithm as recited in claim 1 wherein the number of predetermined sections screened during the screening step is two.

7. The method of preventing an attack on a screening algorithm as recited in claim 1 further comprising the step of determining a total length of time of the content prior to the screening step.

8. The method of preventing an attack on a screening algorithm as recited in claim 1 wherein the predetermined number of sections is equal to two for content having a duration of about three minutes or less.

9. The method of preventing an attack on a screening algorithm as recited in claim 8 wherein the predetermined number of sections is incremented by one for each one minute of duration over the initial three minutes.

10. The method of preventing an attack on a screening algorithm as recited in claim 1 wherein the predetermined number of sections to be screened is a function of a duration of time for the content.

11. The method of preventing an attack on a screening algorithm as recited in claim 1 wherein the predetermined number of sections to be screened is dynamically determined as a function of a desired level of security versus a desired level of performance.

12. An apparatus for preventing an attack on a screening algorithm comprising:
a processor device; and
a memory device, wherein the processor device processes a screening algorithm stored on the memory device for screening content identified to be downloaded, wherein at least two sections of content are screened by the screening algorithm.

13. The apparatus for preventing an attack on a screening algorithm as recited in claim 12, wherein an additional section of content is screened by the screening algorithm for each minute of content in excess of a first three minutes of content.

14. An article of manufacture for preventing an attack on a screening algorithm, the article comprising a machine readable medium containing one or more programs which when executed implement the steps of:
identifying content to be downloaded;
determining a total number of sections of a predetermined duration of time in the content to be downloaded; and
screening a predetermined number of sections of the total number of sections to determine whether the predetermined number of sections verify correctly through the screening algorithm.

15. The article of manufacture for preventing an attack on a screening algorithm as recited in claim 14 wherein the predetermined duration of time of one or more of the total number of sections is fifteen seconds.

16. The article of manufacture for preventing an attack on a screening algorithm as recited in claim 14 further comprising the step of determining a total length of time of the content prior to the screening step.

17. The article of manufacture for preventing an attack on a screening algorithm as recited in claim 14 wherein the predetermined number of sections is equal to two for content having a duration of three minutes or less.

18. The article of manufacture for preventing an attack on a screening algorithm as recited in claim 14 wherein the predetermined number of sections is incremented by one for each one minute of duration over the initial three minutes.
